(19) United States
(12) Patent Application Publication
(10) Pub. No.: US 2006/0242302 A1
(43) Pub. Date: Oct. 26, 2006

(54) Proof-of-service (POS) workflow customization via task extension

(76) Inventors: Arthur P. Walker, Ellicott City, MD (US); Brian M. Hale, Manchester, MD (US)

Correspondence Address: MANELLI DENISON & SELTER PLLC, 7th Floor, 2000 M Street, N.W., Washington, DC, 20036-3307, US

(21) Appl. No.: 11/152,726

(22) Filed: Jun. 15, 2005

Related U.S. Application Data
(60) Provisional application No. 60/673,774, filed on Apr. 22, 2005.

(51) Int. Cl. G06F 15/16

(52) U.S. Cl. 709/227

(57) ABSTRACT

Task extensions for a proof-of-service (POS) system allow easy customization without requiring modification to the POS application itself. Current preferences capability is used to specify new tasks, which are downloaded to the device during an administrative sync process. The new workflows are detected at runtime. This provides a way to collect additional customer-defined data associated with a given task. Ideally, task extensions could be used with both the existing tasks (delivery and pickup) and with new tasks that would be defined by a customer. Data collected by the workflow extension is returned as an XML-tagged string of data elements to the legacy system, which would be responsible for parsing the data. Some rudimentary data validation on the client may be included by adding attributes to the XML-tags that define the UI's data collection elements.

This application claims priority from U.S. Provisional Patent Application No. 60/673,774, entitled “Task Extension in Proof of Delivery/Service System”, filed Apr. 22, 2005, the entirety of which is expressly incorporated herein by reference.

### BACKGROUND OF THE INVENTION

1. Field of the Invention

This invention relates generally to proof of service (POS) client workflow management systems, and more particularly to proof of delivery systems.

2. Background of the Related Art

Proof-of-Service (POS) applications are used to track whether a service has been performed. A service is some task, such as delivery of a package, that the service provider wishes to track by collecting data at the time the service is provided. The steps that are performed to collect the service data are known as the service workflow. Existing POS applications provide a small set of standard service workflows (usually for delivery and pickup services) that can be tracked by the application. Many service providers have services that they would like to track that are not covered by the POS application's standard workflows.

Conventional proof of delivery client applications support two tasks that can be associated with each package or carton—delivery and pickup. (Note: Although a delivery or a pickup is often referred to as a “service”, this term is also confusingly used to refer to a type of record that is associated with a completed stop. To avoid confusion, in this document the term “task” is used to describe the action associated with each carton at a stop, and thus the new feature proposed by this document is called a “task extension”.)

Conventional client proof-of-delivery (POD) applications (or more generally proof-of-service) allow cartons in an order to be handled in one of two ways—a carton can either be delivered, or a carton can be picked-up. The system ostensibly supports the capability to extend the number of tasks, but adding a new task in reality does nothing more than provide a new task name that can then be accessed on the device. In other words, no changes or additions to the existing task workflow are included by virtue of adding a new task; workflow changes require modifying the source code on the client. Of course, such a change to the client required that a new build of the client application be deployed to the customer. This presents a tremendous logistical challenge.

POS providers whose requirements fall outside the standard workflows must either adapt their processes to fit the standard workflows, or ask the application vendor to implement one time changes to customize the application. Forcing a service provider to adapt their processes to the standard workflows provided by a POS application can result in some data not being captured, and in end-user confusion due to a poor fit between the provider's requirements and the standard workflows. On the other hand one-off changes to the application can be expensive, may not be able to be done in time to meet the service provider's needs, and can multiply the application vendor's testing and maintenance costs.

There is a need for a more flexible and capable proof of delivery/service system.

### SUMMARY OF THE INVENTION

In accordance with the principles of the present invention, task extensions allow the POS application to be quickly and easily customized without requiring the POS application itself to be modified. Rapid turnaround is provided for customers that may want to add additional tasks with specific data collection requirements. The present invention uses current preferences capability to specify new tasks and the user interface (UI) elements used to collect data associated with each new tasks. New tasks are defined in preferences, which are configuration properties that are downloaded to the device during an administrative synchronization process referred to as an “admin sync”. New workflows are added to a task such that the application detects the new workflows at runtime. This capability, known as a task workflow extension or, more simply, task extension, provides a way to collect additional customer-defined data associated with a given task. Ideally, task extensions could be used with both the existing tasks (delivery and pickup) and with new tasks that would be defined by the customer.

In an aspect of the present invention, a proof of service system is provided including a task workflow extension feature comprising the provision of at least one editable form defined using a scripting language. Scripting language is transmitted to a client via configuration properties (i.e., “preferences”).

### BRIEF DESCRIPTION OF THE DRAWINGS

FIG. 1 shows an example single form workflow for a task extension module of a proof of delivery/service system, in accordance with the principles of the present invention.

FIG. 2 shows an example retrace workflow example for a task extension module of a proof of delivery/service system, in accordance with the principles of the present invention.

FIG. 3 shows a linear workflow example for a task extension module of a proof of delivery/service system, in accordance with the principles of the present invention.

FIG. 4 shows an example of a workflow combining linear and retrace workflows for a task extension module of a proof of delivery/service system, in accordance with the principles of the present invention.

FIG. 5 shows an example task extension editor main form for a task extension module of a proof of delivery/service system, in accordance with the principles of the present invention.

FIG. 6 shows an example task extension editor edit task form for a task extension module of a proof of delivery/service system, in accordance with the principles of the present invention.

FIG. 7 shows an example task extension form example for a task extension module of a proof of delivery/service system, in accordance with the principles of the present invention.

FIG. 8 shows an example task extension editor edit form for a task extension module of a proof of delivery/service system, in accordance with the principles of the present invention.

FIG. 9 shows an example task extension editor edit label form for a task extension module of a proof of delivery/service system, in accordance with the principles of the present invention.

FIG. 10 shows example task extension editor edit textbox forms for a task extension module of a proof of delivery/service system, in accordance with the principles of the present invention.

FIG. 11 shows an example task extension editor edit popup form for a task extension module of a proof of delivery/service system, in accordance with the principles of the present invention.

FIG. 12 shows example forms with 1 additional button and 2 additional buttons for a task extension module of a proof of delivery/service system, in accordance with the principles of the present invention.

FIG. 13 shows an example task extension editor edit button form for a task extension module of a proof of delivery/service system, in accordance with the principles of the present invention.

FIG. 14 shows an example of cutting and pasting task extension purpose data for a task extension module of a proof of delivery/service system, in accordance with the principles of the present invention.

### DETAILED DESCRIPTION OF ILLUSTRATIVE EMBODIMENTS

In accordance with the principles of the present invention, task extensions allow the POS application to be quickly and easily customized without requiring the POS application itself to be modified. To allow for rapid turnaround for customers that may want to add additional tasks with specific data collection requirements, the present invention uses current preferences capability to specify new tasks and the user interface (UI) elements used to collect data associated with each new tasks. New tasks are defined in preferences, which are configuration properties that are downloaded to the device during an admin sync.

The present invention adds new workflows to a task such that the application detects the new workflows at runtime. This capability, known as a task workflow extension or, more simply, task extension, provides a way to collect additional customer-defined data associated with a given task. Ideally, task extensions could be used with both the existing tasks (delivery and pickup) and with new tasks that would be defined by the customer.

At its most basic, a task extension comprises a single form that contains at least one data entry field. When the driver taps on the task button (e.g., labeled either Deliver or Pickup) on the Package Delivery form, the application would go to the task extension form and allow the user to enter the additional data before completing the task. One example of the concept is carton barcode scanning when a pickup is performed.

Due to the nature of the extension, the proof of service/delivery server might not have the appropriate insight into the nature of the data to be able to perform any data validation or referential-integrity checking of the data. Thus, data collected by the workflow extensions is returned as an XML-tagged string of data elements to the legacy system, which would be responsible for parsing the data. Some rudimentary data validation on the client may be included by adding attributes to the XML-tags that define the UI's data collection elements.

This workflow extension capability is a powerful sales tool. Imagine a proof of delivery system salesperson being able visit a customer in the morning, gather basic task workflow requirements, and be able to demonstrate the additions later the same day.

Originally, consideration was given to an XML-based user interface definition language such as XUL to define the task extension UI, but it was found to be too verbose for task extension purposes. Instead, it is preferred that all data that describes the UIs be included in tilde-separated (˜) list of attributes. The tilde is used as a separator in the attribute list in order to simplify parsing of the list; tildes are far less common in normal text then commas or semicolons, the usual candidates for separators in a list.

Workflow extensions may be defined by adding Preference table entries that describe the UI forms that would be used to collect Task Extension data. Preferences are sent to the client during an admin sync process. In this way, task extension screens can be added or updated by simply modifying the server's preferences, then forcing the device to perform an admin sync process.

To add a task extension, in the given example, a new task name is first added to the server's Purpose table. Then a set of preferences is added to the server's Preference table to describe the UI forms and elements that comprise the task extension. In the disclosed embodiment, each preference key related to a task extension has the prefix ext.taskName., where taskName is the name of the task added to the Purpose table. This name may be case-sensitive, in which case the name in the Purpose table and the name in the preference key must match exactly.

The forms associated with the task extension may be listed in a single preference that has the format ext.taskName.formList. One or more forms may be named in the task's form list, with each name separated by a tilde. For example, to add a task extension named Shred with two forms named shredForm and noteForm, the following key and value pair would be added to the preferences:

ext.Shred.formList shredForm˜noteForm

The first form in the list is considered the main form—in other words, it is the form that will be opened when an Accept button is selected in the Package Delivery form for cartons whose purpose code matches the task. In the above example, shredForm is the main form for the task.

For each form named in the form list, preferences are defined that describe the UI elements (text prompts, data entry fields, popup menus, etc.) that the form contains. The preference keys for the UI elements are named using the format ext.taskName.formName.X, where X is a value from 1 to the number of UI elements in the form. For example, consider a task extension named Shred that contains a form named shredForm which contains 4 UI elements. To define the UI elements for this form, preferences with key strings ext.Shred.shredForm.1 through ext.Shred.shredForm.4 would be added to the preference table.

In the disclosed embodiment, there are four types of UI elements that can be defined—BUTTON, LABEL, POPUP and TEXTBOX. Of course, the use of more or fewer types of UI elements are within the principles of the present invention. The format used for each of the UI element descriptors is shown below:

BUTTON˜tag˜label˜form

LABEL˜tag˜xpos˜ypos˜width˜height˜textString˜alignment

POPUP˜tag˜xpos˜ypos˜width˜height˜required˜default˜itemCount˜item_{—}1˜ . . . it em_N˜description

TEXTBOX˜tag˜xpos˜ypos˜width˜height˜required˜multiline˜scanable˜default˜minVal˜maxVal˜maxChars˜validChars˜description

A BUTTON descriptor may be used to add buttons to the form. Although each disclosed form always contains at least 2 buttons—an OK button and a Cancel button—the BUTTON descriptor allows up to 2 additional buttons to be added to the form. Of course, more buttons may be added within the principles of the present invention. BUTTON can also be used to re-label the existing buttons OK and Cancel buttons (for example, they could be changed to read Yes and No).

Static text UI elements are defined using LABEL. Typically every TEXTBOX or POPUP data entry element will have an associated LABEL element that describes to the user what the data entry element represents.

The POPUP element defines a popup menu that contains a list of options from which the user can select one item. Attributes for POPUP include size and position information, a default selection, and whether or not a selection is required.

TEXTBOX may be used to define a data entry text field. In addition to attributes describing the size and position of the field, TEXTBOX also has attributes that specify whether or not data can be scanned into the field using a barcode scanner, a default value for the field, and data validation criteria.

The following table describes the attributes associated with the UI element descriptors.

| Attribute | Description |
|---|---|
| alignment | String that defines the alignment (or justification) |
| | of a text string within the region defined for the |
| | string. Value values are “LEFT”, |
| | “CENTER”, or “RIGHT”. This attribute |
| | may be optional. The default alignment is LEFT. |
| default | The default value for the data entry element. For |
| | TEXTBOX elements, this is the string that may |
| | appear in the textbox when the form is first |
| | displayed. For POPUP elements, this is the string |
| | that matches the menu selection that may be |
| | selected when the form is first displayed. This |
| | attribute may be optional. |
| description | Text that may be used to describe the field if |
| | it's necessary to display an error message due |
| | to missing data when the ‘required’ |
| | attribute is true, or for out-of-range errors if |
| | minVal or maxVal are set. This attribute may be |
| | optional; if it isn't defined, the tag may |
| | be used in error messages. |
| itemCount | Integer defining the number of items in the |
| | POPUP element |
| item_N | String defining a menu selection in a POPUP |
| | element |
| maxChars | Numeric value that defines the maximum number of |
| | characters that can be entered into the TEXTBOX |
| | field. This attribute may be optional, in which |
| | case there is no restriction on the number of |
| | characters that can be entered into the field. |
| | Typically this should not be defined if minVal |
| | or maxVal is defined. |
| minVal, maxVal | The minimum and maximum valid values that the |
| | user can enter into a TEXTBOX. If either of |
| | these values is defined, then it will be assumed |
| | that the TEXTBOX can only accept numeric |
| | input. These attributes may be optional. |
| multiline | Boolean entry which defines whether the TEXTBOX |
| | is capable of accepting multline input; value |
| | values are T (true) or F (false). This attribute |
| | may be optional. The default is false. |
| required | Boolean entry which defines whether the user |
| | is required to supply a value for this item; |
| | value values are T (true) or F (false). This |
| | attribute may be optional. The default is true. |
| scanable | Boolean entry which defines whether the textbox |
| | is capable of accepting scanned input; value |
| | values are T (true) or F (false). This attribute |
| | may be optional. The default is false. |
| | If only one TEXTBOX in a form is scanable, then |
| | a scan may always be written to that object, |
| | regardless of which one has the input focus. |
| | However, if more than one TEXTBOX is scanable, |
| | then a scan may only be written to a given |
| | object if it has the input focus. |
| tag | A descriptor for the element. For data entry |
| | (POPUP and TEXTBOX) elements, the tags should |
| | be unique within the entire task because |
| | it is used to construct the XML tag used |
| | to delimit the data returned from the UI data |
| | entry element. For BUTTON elements, the tag |
| | is generally just a unique identifier that |
| | isn't used unless it is “OK” or |
| | “CANCEL”, in which case it means that |
| | the button element modifies the behavior of |
| | one of the standard buttons. For LABEL |
| | elements, the tag may be ignored when building |
| | the UI. If a LABEL is associated with a data |
| | entry element, then it is often convenient to |
| | give the LABEL the same tag as the data |
| | entry element. |
| textString | Text used for either the title or a prompt |
| validChars | String that defines all possible characters |
| | that can be entered into the TEXTBOX field. |
| | This attribute may be optional, in which case |
| | there is no restriction on what characters can |
| | be entered into the field. Typically this |
| | should not be defined if minVal or maxVal is defined. |
| xpos, ypos, | Size and position of the UI element. The |
| width, height | coordinate system is device-dependant. On the |
| | PPC, the upper left corner of the screen is |
| | (0, 0), while the lower right is (230, 230). Also, |
| | the aspect ratio (height/width) on the PPC is |
| | not 1:1 - in other words, a 10 × 10 |
| | element will not appear to be exactly |
| | square when displayed on the device. |

In addition to the UI elements defined in the preferences, each Task Extension preferably has an OK button and a Cancel button. When the OK button is tapped, the data will be collected and validated. If all the data is valid, it will be packed into a XML-encoded data string and added to the orderItem record, and the task will be considered completed.

There may be two additional Task Extension preferences that can be defined independently of whether or not form and UI element preferences are specified. The ext.taskName.button preference defines the label that may be used in the task button on the Deliver Packages screen when a carton associated with the task is selected in the list. In the disclosed embodiment, this button is labeled “Deliver” when a delivery is selected, “Pickup”when a pickup is selected, and “Accept” when any other task is selected. The ext.taskName.shortcut preference defines the single character that will be used to represent the task in tables and summary data. By default, the shortcut characters for the Delivery task and the Pickup task are “D” and “P”.

Both the Purpose and the Preference tables are synced to the client during an admin sync process. Once the admin sync process is performed, the client may iterate through the Purpose table and use the name of each task to construct preference keys to lookup the UI elements in the preference table. If no UI elements are found in the preferences, then the app may behave otherwise in a conventional manner. However, if UI elements are found, then they would be retrieved and used to construct the appropriate forms whenever the driver taps the task button in the Deliver Packages form.

To store the extension task data, a new field named extData may be added to the orderItem table on the client and server. This field is a string field, and care should be taken when specifying the size of the string in the server database to insure that data isn't lost when storing the item in the database. The legacy interface will also need to be updated to provide a way to either push the task extension data back to the legacy system, or to provide a means for the legacy system to query the 20/20 server to retrieve this data as needed.

A specific application of the principles of the present invention are described with respect to an embodiment of a task extension editor in a proof of delivery system for use on a PocketPC™ device.

In particular, an exemplary proof of delivery (POD) client application for the Pocket PC (PPC) implements a feature that allows task workflow extensions to be added to the application using a scripting language that is transmitted to the client via preferences. Although it is possible to define task extension workflows by manually defining the preferences needed to tell the POD client app how to render the forms that comprise the workflow, this can be a tedious and error-prone operation. A better way exists—the task extension editor (TEE).

The TEE is an application that runs on a Pocket PC device or a PPC emulator that can be used to define task extension workflows. Using the TEE, the designer specifies the forms that belong to a task's workflow, and specifies the UI elements (labels, text entry fields, etc.) that comprise each form. Task extension workflow can be implemented using the TEE for both existing tasks (e.g. Deliver or Pickup) and for new tasks.

To verify the workflow design, the TEE provides a preview mode that allows the designer to view and test a task extension workflow's forms. Since this preview mode uses the same plugin module that the POD application uses to render the task extension forms, the designer can guarantee that forms defined using the TEE will be rendered correctly by the POD application.

The TEE can also be used by members of the POD sales team to provide ad-hoc demos of task extension enhancements for potential customers. This can be done in near-real time by first sketching out task extensions using the TEE according to a customer's requirements. For basic forms, this is a fairly simple operation. Then, with the actual POD application program running in demo mode on the same device, the customer can be shown how the task extensions interact with the main application.

Workflow Design Primer

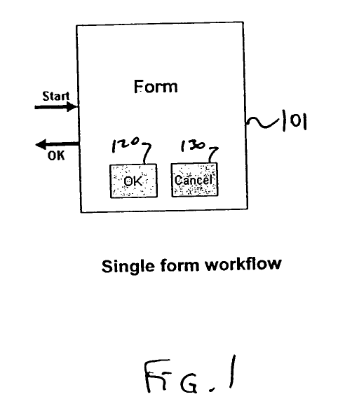

A workflow is simply a series of steps that are used to accomplish a task. From the perspective of the POD client, a workflow is implemented as a collection of forms that are used to collect driver data associated with the task. At its most basic, a workflow consists of a single form 101, as shown in FIG. 1. In a single form workflow, all of the information that the driver needs to enter for the task is entered on the one form, and once the driver is finished entering data, the driver taps OK and the task is completed.

It is very likely that most task extension workflows will consist of a single form 101. This makes the workflow designer's job fairly simple—all that's needed is for the designer to layout the data entry elements on the single form 101. However, it is possible that the workflow designer will find that all of the data required for the task cannot be entered on a single form 101, in which case it would be desirable to create a workflow with two or more forms. At this point, the designer has to decide how to navigate between the workflows forms to best guide the driver through the steps required to enter the task data. There are two basic techniques used when implementing a multiple-form workflow-retrace workflow navigation, and linear workflow navigation.

Retrace Workflow

A retrace workflow is entered and exited from the same form 101, which is referred to as the main form of the workflow. From the main form 101, the user can go to other forms, but will always return to the main form 101 to complete the task. The main form should always contain an OK button 120 and a cancel button 130. Additional buttons are added to the main form 101 to allow the user to navigate to the task's other forms.

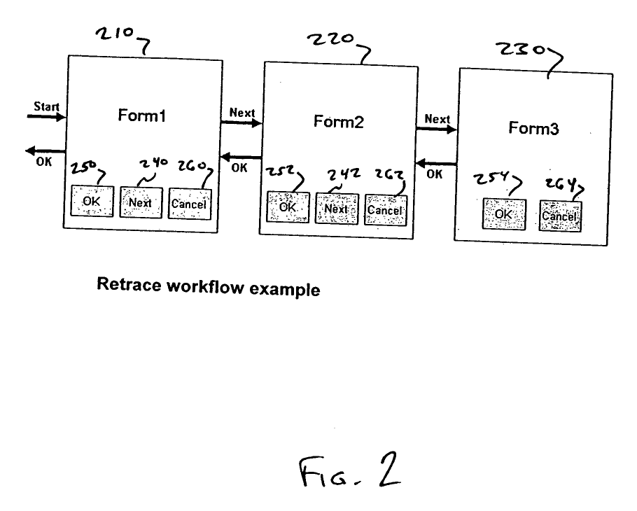

FIG. 2 shows an example of a simple retrace workflow consisting of multiple forms, e.g., three forms 210, 220, 230. In FIG. 2, navigation to the next form 220, 230 in the workflow is accomplished using the next buttons 240, 242 of the previous form 210, 220, respectively. Note that although “next” is used in this example, the label on the button that is used to navigate to the other form can be any text that fits in the button and succinctly describes the operation that the button performs.

In the disclosed example, there are no other forms in the workflow past the third form 230, so the third form 230 need not contain a next button. In each form 210, 220, 230 in the workflow, when the user taps the respective OK buttons 250, 252, 254, data is collected from the respective form 210, 220, 230 and the user is returned to the previous form. Tapping a suitable cancel button 260, 262, 264 may also be used to return the user to the previous form, but no data is collected in such case.

When the OK button 250 is tapped in the main form 210, the workflow is completed. If instead the cancel button 260 is tapped, the workflow exits without finishing the task.

Linear Workflow

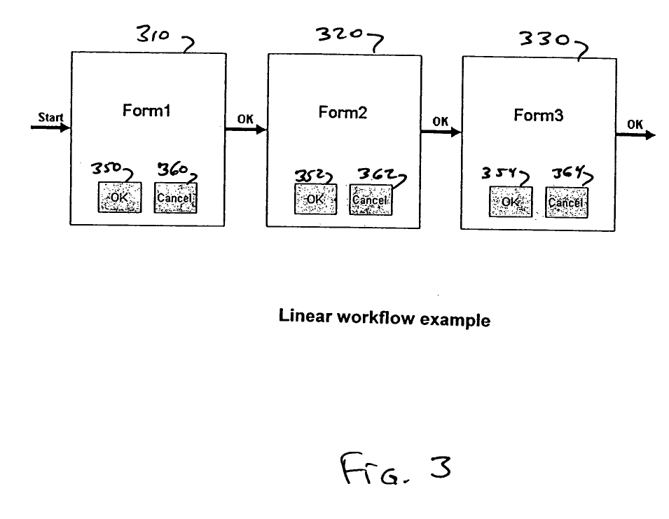

A linear workflow may be formed. A linear workflow consists of a series of forms that are accessed in sequence to complete a given task. FIG. 3 shows an example of a simple linear workflow.

In particular, as shown in FIG. 3, unlike the retrace workflow shown in FIG. 2, in a linear workflow the user does not return to the first form to complete the task. FIG. 3 shows three forms 310, 320, 330, each containing an OK button 350, 352, 354 and a cancel button 360, 362, 364. When the user taps a corresponding OK button in a given form, the data is collected from the form and then moves the user to the next form in the sequence. This process is repeated until the OK button 354 is tapped in the last form 330 in the sequence, at which point the task is completed. Tapping the cancel button 360, 362, 364 in any of the forms 310, 320, 330 in the linear workflow discards any data entered in the current form and then moves the user back to the previous form.

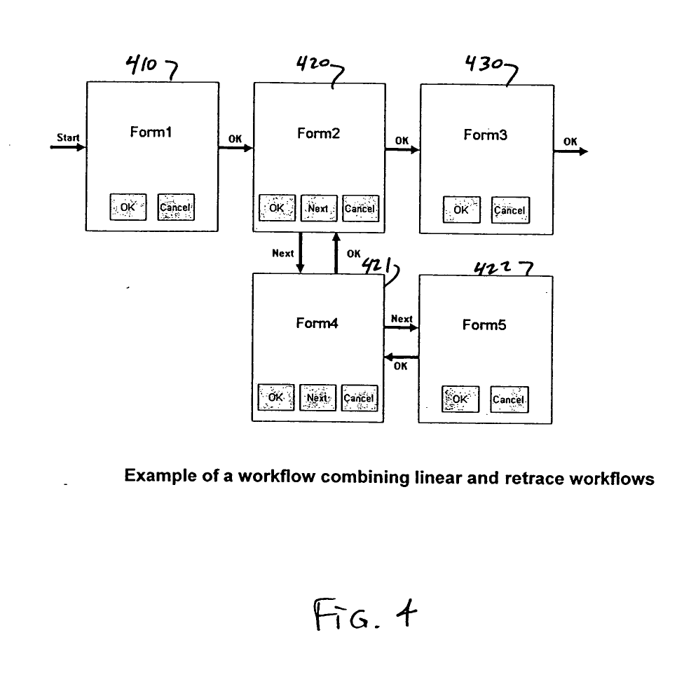

Complex workflows may be created comprising a combination of retrace and linear workflows. FIG. 4 shows an example of just such a workflow.

In particular, FIG. 4 shows a workflow comprising both retrace and linear workflows. FIG. 4 shows a series of forms 410, 420, 430 forming a linear workflow. One of the forms 420 branches off as the main page to a retrace workflow formed by forms 420, 421 and 422.

As an example of a combined workflow in a POD client application, a package delivery workflow may be implemented comprising a linear workflow from which retrace workflows such as an adjustment workflow can be accessed.

Generally speaking, in the realm of POD task extensions, it is unlikely that a workflow will require more than two or three forms. It is desirable that a task extension designer strive to implement a workflow using a minimal number of forms (e.g., using a single form). However, when multiple forms are required, then the decision on whether to use a retrace workflow or a linear workflow hinges on one major issue—“Is data to be entered on each form required, or is it optional?”

If the data on each form is determined to be required, then a linear workflow is typically the better approach because it forces the user to step through each form to complete the given task. However, if some data is optional, then a retrace workflow is usually called for because it can be used to move the data entry chores for the optional data to ancillary forms. Using a retrace workflow for optional data reduces clutter on the main form and avoids confusing the user with data entry options on the main form that are not required.

### Task Extension Editor (TEE)

The disclosed embodiment describes the use of a scripting language to define task extensions. A task extension editor (TEE) application is used to generate these scripts. Using the TEE, a user specifies the forms that belong to a task's workflow, and specifies the UI elements (labels, text entry fields, etc.) that comprise each form. The ideal TEE provides the ability to preview the task extensions prior to deploying them on a client device.

Main Form

When the exemplary TEE is launched on a client device, it checks the POD databases to determine what tasks and task extensions are already defined on the device, and displays the tasks in a list in the TEE Main form.

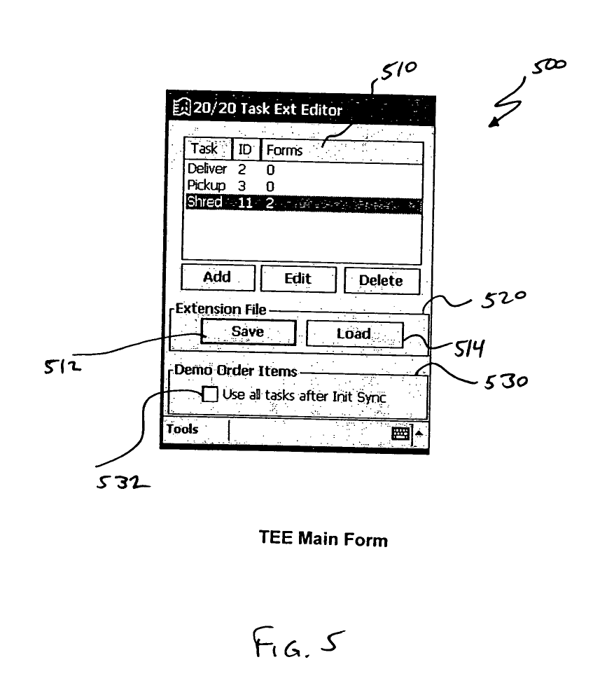

FIG. 5 shows an example task extension editor main form for a task extension module of a proof of delivery/service system, in accordance with the principles of the present invention.

In particular, FIG. 5 shows an example of a main form 500 with two standard tasks (Deliver and Pickup) and three additional tasks. The number in the Forms column 510 indicates the number of task extension forms that have been added to each task. From the main form 500, the user can add a new task, or select an existing task to edit or delete. Although the example shown in FIG. 5 indicates that there are no task extensions for Deliver and Pickup, the two tasks could have extension forms added to them if needed.

The section of the form labeled Extension File 520 is used to save the task extension data to a file, and to load task extension data from a file. When the save button 512 is tapped, the task extension data is saved to a suitable file (e.g., taskExt.txt) in a suitable log directory on the device.

The data may be written to the file in three different formats—preference key/value pairs, Oracle SQL commands, and Microsoft SQL Server SQL commands. The key/value pairs are read by the TEE application when the load button 514 is tapped. The two SQL command formats are written for use in a customer's database customization script.

Once the task extension design is complete, all the designer has to do to add the preferences to the server database is to tap the save button 512, retrieve the taskExt.txt file from the device using Active Sync, and then cut and paste the appropriate SQL commands from the file into the database customization script.

The Demo Order Items section 530 of the main form 500 contains a checkbox 532 which is used to specify whether order items in demo mode should be modified to use all the tasks.

In demo mode, the order items are loaded from a data file to simulate the init sync. The data in the demo data file includes the task type (a.k.a. purpose type or service type) of each order item. Any new tasks added using the TEE will not be represented in the demo data, so normally it would not be possible to run the POD application in demo mode using the new tasks. However, if this checkbox 532 is checked, then in demo mode the POD application will evenly distribute all of the task types across all of the order items, overwriting the original task type as necessary.

For example, if there are the five task types in the main form 500 shown in FIG. 5, then after the order items are loaded, the first item will have task type 2 (Deliver), the next will have task type 3, the next task type 11, the next task type 12, the next task type 13, and then the next one will be set to task type 2, and the sequence will be repeated through the remaining order items.

Edit Task form

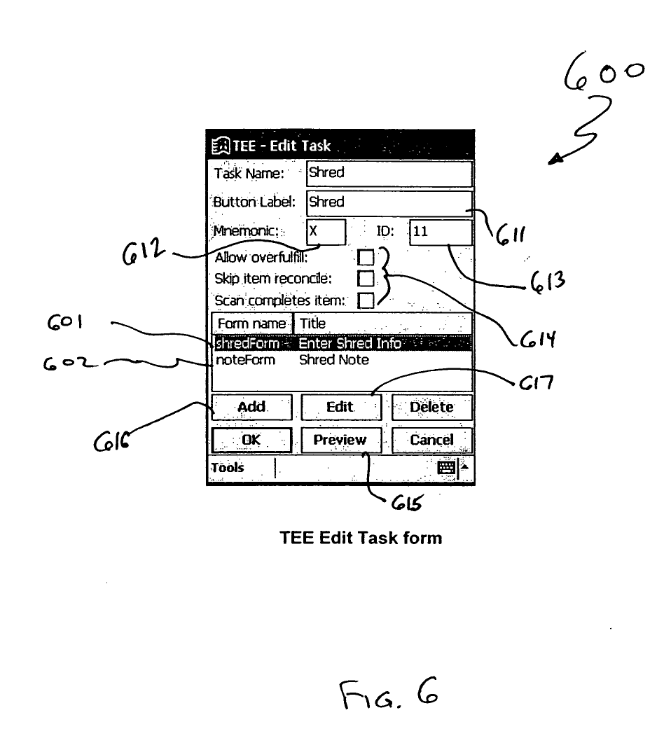

The Edit Task form is used to define the behavior of a task when order items associated with the task are displayed in the POD application's Deliver Package form. FIG. 6 shows an example of an Edit Task form 600 for a task named Shred containing 2 task extension forms 601, 602. At a minimum, a button label 611 and a mnemonic should be defined for each new task.

The button label 611 represents the text that will appear in the Accept button on the Deliver Package form when an order item is selected in the Deliver Package form's item list.

The Accept button is the button that, when tapped, completes the task or, optionally, launches the task extension workflow. Of course, any appropriate label for the Accept button may be used. For instance, in other embodiments of the POD application embodying the invention, the Accept button is labeled either Deliver or Pickup depending on the task type of the item selected in the item list. Although the button label will typically be the same as the task name, it may be necessary to provide a different label if the task name is too long to fit into the Accept button on the device.

The mnemonic entry 612 on the Edit Task form is used to define the single character that will represent an item's task type in the Deliver Package form's item list. Although a mnemonic is usually the first character of the task name (e.g. “P” for Pickup, “D” for Deliver), it is not a requirement, as indicated in the example in FIG. 6, where the Shred task's mnemonic is defined as “X”.

The ID block 613 is the identifier for the new entry that will be created in the Purpose table. Each entry in the table should have a unique ID, and when a new task is created the TEE will suggest an ID that does not conflict with any existing IDs in the purpose table. The user is free to change the suggested ID.

Checkboxes 614 in the Edit Task form may be used to set flags that are associated with each task. The following table describes the purpose of each of the flags shown in the exemplary form of FIG. 6.

| Flag | Default | Description |
|---|---|---|
| AllowOverfulfill | false | If true, items of this type can |
| | | have positive adjustments. |
| SkipItemReconcile | false | If true, items of this type will |
| | | not be reconciled during order |
| | | item reconciliation. This flag |
| | | is set true to avoid forcing the |
| | | driver to reconcile items (for |
| | | example, pickups) that typically |
| | | won't be available to scan |
| | | during item reconciliation. |
| ScanCompletesItem | false | If true, then scanning an item of |
| | | this type will cause the full |
| | | quantity to be accepted in the |
| | | Deliver Packages form. If false, |
| | | then the behavior would be the |
| | | same as the standard behavior in |
| | | pre-5.0 versions of the client - a |
| | | scan decrements the quantity by 1. |
| | | This feature was added to |
| | | accommodate customers who want to |
| | | use the quantity field to describe |
| | | an amount for an item that can't |
| | | readily be scanned many times to |
| | | accept the item. An example of |
| | | this would be a customer who |
| | | wants the quantity to represent |
| | | the number of gallons to be |
| | | delivered - in such a case, |
| | | forcing the driver to scan |
| | | once for each gallon delivered |
| | | obviously wouldn't make |
| | | much sense. |

The Preview button 615 on the Edit Task form 600 allows the user to execute the task workflow using the same plugin that the POD application uses to run the workflow. When the workflow consists of more than one form, then this means that the user will be able to step through each form in the workflow, assuming of course that the forms are defined such that there are links between the forms (links are described in more detail in the section covering the Edit Form form). Regardless of whether a workflow is implemented as a linear or as a retrace workflow, the form at the top of the Edit Task form's list is always the first form that will be activated. Thus, in the example in FIG. 6, the shredForm form 601 is the first form displayed in the task workflow, while the noteForm form 602 must somehow be accessed via a link from the shredForm form 601.

Edit Form Form

Tapping the Add button 616 or selecting a form and then tapping the Edit button 617 in the Edit Task form 600 takes the user to the Edit Task form 600.

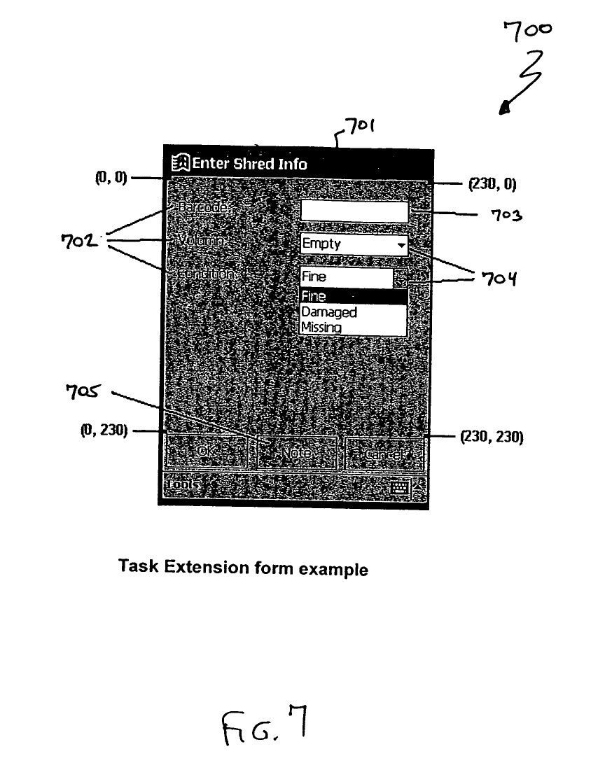

The Edit Task form 600 is used by the designer to add, modify, and delete user interface (UI) elements on the selected form. There are four types of UI elements that can be added to a task extension form—buttons, labels, popup menus, and textboxes. Examples of each of these elements are shown in FIG. 7.

In particular, as shown in FIG. 7, the form 700 includes a title 701 of the form, labels 702, a textbox 703, a popup 704, and a button 705.

When a UI element is added or edited, the user is taken to an element-specific form to enter the element parameters. For the label, textbox, and popup menu elements, these parameters include the relative size and position of the element. The position of a UI element on a PPC form is specified using an X,Y coordinate system in which the upper left corner of the form is coordinate (0, 0), and the lower right corner is (230, 230); these corner coordinates are shown as red dots in FIG. 7. Note that the Y coordinates increase from top to bottom, which is inverted compared to a standard Cartesian X,Y coordinate system.

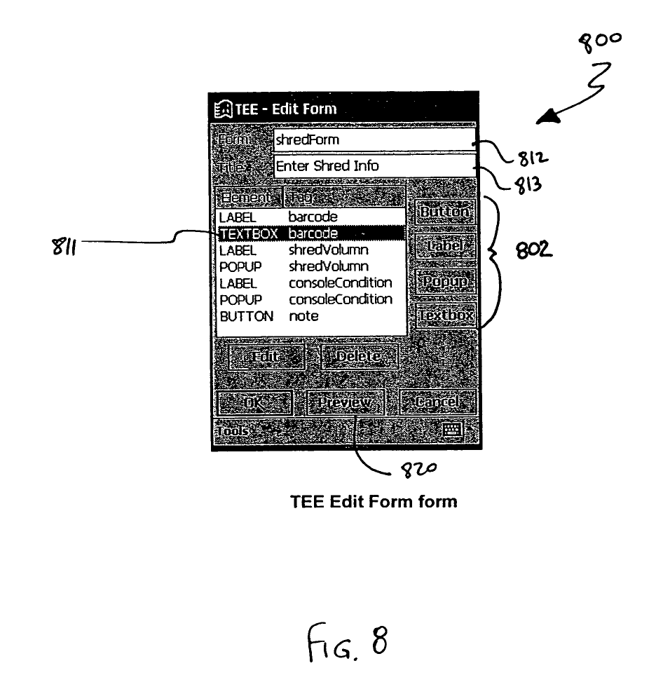

An Edit Form Form 800, shown with sample data in FIG. 8, is used for defining the appearance of the Edit Task form by providing the means for the user to add, modify, and delete these UI elements on a form. To add a new UI element to a form, the user taps the appropriate UI element button 802 on the right side of the Edit Form form. As elements are added, they will appear in the Edit Form form's element list, from where they can be selected for editing or deletion. Each entry in the element list contains the element type, and an element tag.

A tag is a user-defined name that identifies a UI element. Within a given task workflow, the tags associated with data entry elements (textboxes and popup menus) should be unique, because the tag is used to identify the data collected from a given data entry element when the data is returned to the legacy server. The tags associated with label elements do not have to be unique, because there is no data collected from these elements. As a matter of convenience, it is usually good practice to make a label's tag the same as the tag of its associated data entry element. For example, in the sample data shown in FIG. 8, the textbox 811 with the tag name ‘barcode’ has an associated label that shares the same tag name. Likewise, the two popup menu elements 812, 813 in the example each have an associated label that shares the popup menu's tag name.

The Edit Form form 800 contains a Preview button 820 that can be used to preview the appearance and behavior of the form as it is being built. Like the preview mode available from the Edit Task form, this preview mode uses the POD application's own task extension plugin to render the task extension form. This form preview mode differs from the task preview mode in that there only the single form being edited is previewed, whereas when the task preview mode is used from the Edit Task form the entire workflow is accessible.

Edit Label Form

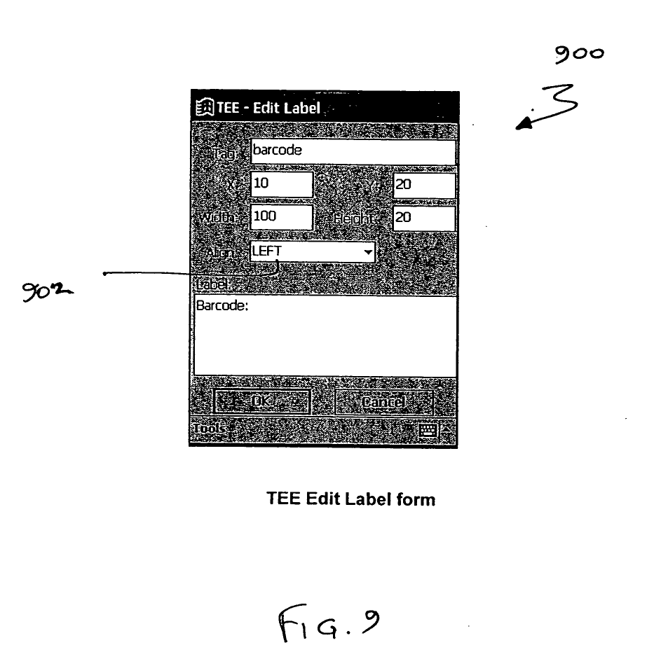

An Edit Label form 900 is used to set the location and contents of text labels in a form. A snapshot of the Edit Label form 900 with sample data is shown in FIG. 9.

When setting, the width and height values are preferably set large enough to avoid chopping off the label text, while at the same time small enough to avoid overlapping other UI elements. The Preview mode of the Edit Form 800 can be used to verify that these values have been set correctly.

In addition to the tag and element position attributes, the Edit Label form 900 also allows the user to specify the alignment of the text within a bounding box defined by the width and height of the label.

An align value 902 of LEFT means the text will be left-justified within the label box, CENTER means it will be centered, and RIGHT means it will by right-justified.

Edit Textbox Form

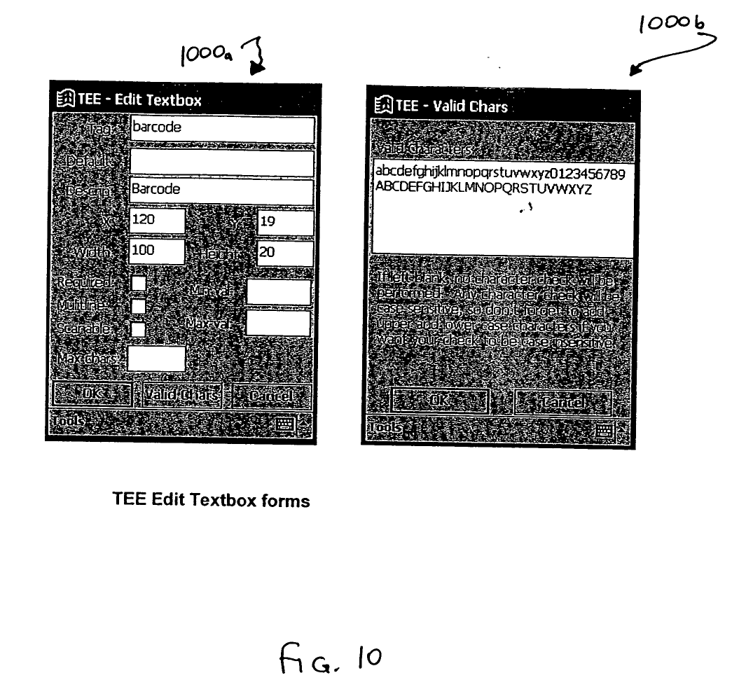

Two examples of Edit Textbox forms (1000a, 1000b, collectively referred to as 1000) are shown in FIG. 10. The Edit Textbox form 1000 is used to specify the characteristics of a textbox, which is a data entry element that allows the user to enter text data. In addition to the size and position of the textbox, the Edit Textbox form 1000 contains fields for defining the parameters described in Table 1.

TABLE 1
Edit Textbox form parameters

| Parameter | Description |
|---|---|
| Default | The default value for the data entry element. This |
| | is the string that will appear in the textbox when |
| | the form is first displayed. This attribute is |
| | optional. |
| Description | Text that will be used to describe the field if |
| | it's necessary to display an error message due |
| | to missing data when the ‘required’ attribute |
| | is true, or for out-of-range errors if minVal or |
| | maxVal are set. This attribute is optional; if it |
| | isn't defined, the tag will be used in error |
| | messages. |
| Required | If checked, then the user will required to supply |
| | a value for this item. |
| Multiline | If checked, then the user will be allowed to |
| | enter multiple lines of text into the textbox. |
| Scanable | If checked, then the data can be input into the |
| | textbox using the barcode scanner. If only one |
| | textbox in a form is scannable, then a scan will |
| | always be written to that textbox, regardless of |
| | which one has the input focus. However, if more than |
| | one textbox is scanable, then a scan will only be |
| | written to a given textbox if it has the input focus. |
| MinVal, | The minimum and maximum valid values that the user |
| MaxVal | can enter into a textbox. None, one, or both values |
| | can be defined. If either is defined, then it will |
| | be assumed that the textbox can only accept numeric |
| | input. Integer or decimal values may be used; if |
| | decimal values are used, then the number of numeric |
| | characters past the decimal point defines the |
| | precision of the number that is entered in the field. |
| | For example, if the MinVal is specified as “1.000”, |
| | then data entered into the TEXTBOX will have up to |
| | 3 decimal places of precision. If the precision of |
| | MinVal and MaxVal does not match, then the maximum |
| | precision of the two will be used. These attributes |
| | are optional. |
| MaxChars | The maximum number of characters that can be entered |
| | into the TEXTBOX field. This attribute is optional, |
| | in which case there is no restriction on the number |
| | of characters that can be entered into the field. |
| | Typically this should NOT be defined if Min Val |
| | or Max Val is defined. |
| Valid Chars | Tapping this button takes the user to a separate |
| | form that contains a field into which the user can |
| | enter which characters are acceptable for input into |
| | the text field. If no characters are |
| | defined, then all characters are valid. |

Edit Popup Form

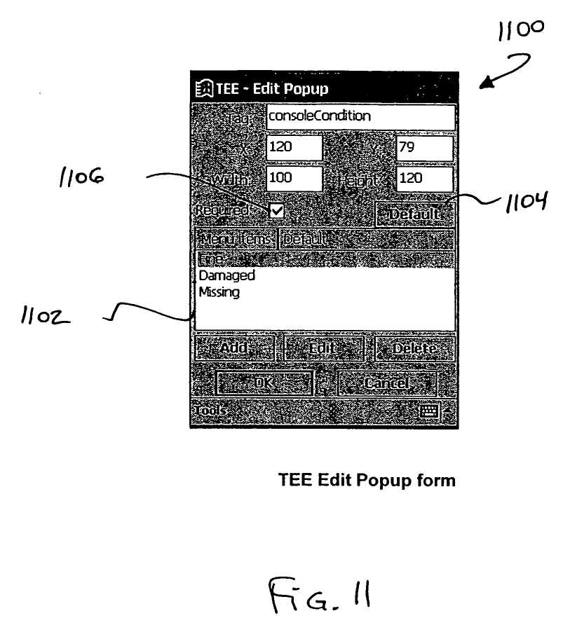

An Edit Popup form 1100 is used to specify the location and contents of a popup menu on the task extension form. As shown in FIG. 11, the Edit Popup form 1100 contains a list of the available options that can be selected from the popup menu. In addition, the Edit Popup form 1100 allows the designer to specify which of the options is the default option. To specify a default, tap an item in the menu item list 1102 and then tap the Default button 1104; the selected default menu item will be marked with an asterisk. If no default menu option is selected, then the popup menu will be blank when it is displayed in the task extension form. When the Required checkbox 1106 is checked, then the user of the task extension form will be required to make a selection from the popup menu. Selecting Required is only necessary if no default option is specified, because if a default is specified then it is not possible to not select an item in the popup menu.

Edit Button Form

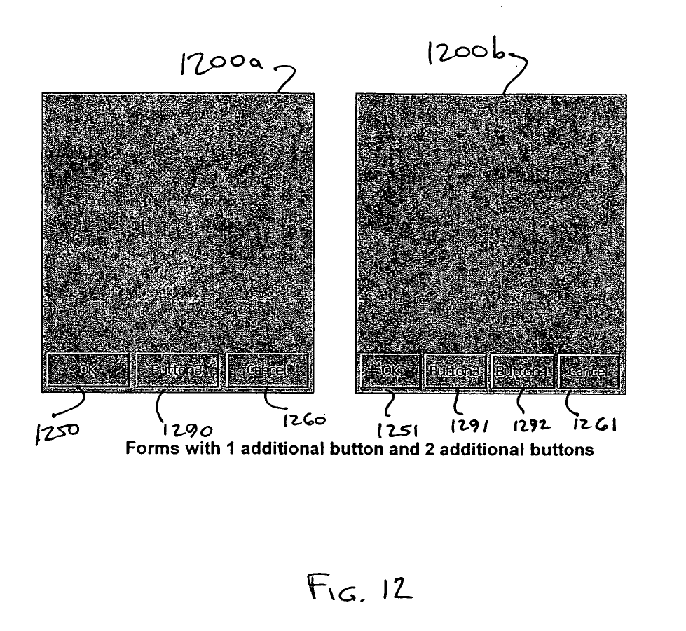

FIG. 12 shows example forms, one form 1200a with one additional button, and another form 1200b with two additional buttons, for a task extension module of a proof of delivery/service system, in accordance with the principles of the present invention.

By default, all task extension forms will have two buttons at the bottom of the form—an OK button 1250, 1260, and a Cancel button 1251, 1261. It is also possible for the designer to add additional buttons to the form, e.g., up to two in the given embodiment, though more would be within the principles of the present invention.

Among all of the UI elements that the designer can add to a task extension form, button elements are unique in that the designer has no control over the location or size of the button. Instead, when a button 1290, 1291, 1292 is added to the form, it is added to the bottom of the form between the OK buttons 1250, 1251 and the Cancel buttons 1260, 1261, as shown in FIG. 12. When a second additional button 1292 is added as in the form 1200b, both additional buttons 1291, 1292 are preferably added between the OK button 1251 and the Cancel button 1261.

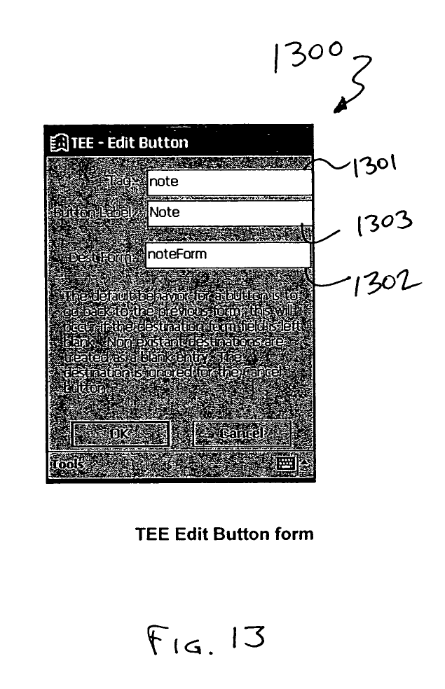

An Edit button menu 1300, as shown in FIG. 13, allows the designer to specify a tag 1301, a button label 1303, and a destination form 1302. Unless the tag 1301 is OK or Cancel, the tag name is ignored by the task extension plugin, but in the disclosed embodiment it still must be provided by the designer.

The button label 1303 is simply the text label applied to the button, and should be defined so that it fits into the dimensions of the button object on the form.

The destination form 1302 specifies which form will be displayed when the task extension form use taps on the button. A destination form 1302 should always be specified for any additional buttons added by the designer, because otherwise the button will do nothing. It is preferably that form names be case-sensitive, so the destination form name must match the name of a form in the task workflow.

In addition to adding new buttons, the Edit Button form 1300 may be used to modify the appearance and behavior of an OK button. The normal behavior of an OK button is to collect data from the form and then return to the previous form, i.e., default OK button behavior models a retrace-type workflow. To implement a linear workflow, the designer must override this default behavior. This is done by specifying a button tag name of “OK” and providing a destination form.

It is also possible to simply change the label of the OK button without changing the behavior. This is done by simply adding an OK button and specifying a new label, but leaving the destination form blank. The Cancel button label can also be changed in a similar fashion—add a button with a tag name of “Cancel” and provide a new label. The behavior of the Cancel button can not be changed, so any destination form entered for the Cancel button will be ignored. One possible reason to change the labels of the OK and Cancel button would be if the form poses a question that requires a Yes or No response—in this case, it would probably be a good idea to change the OK button label to Yes, and the Cancel button label to No.

Creating a Demo Using Task Extensions

Showing a potential customer a demonstration of a POD application containing customer-specific task extensions is a powerful sales tool. Although it is possible to create ad-hoc demos on the spot using the TEE application to create forms, and then use the POD application to display them, this can be a somewhat tricky balancing act trying to jump back and forth between the two applications. Instead, a more likely scenario is that an engineer will be asked to create a demo containing task extensions for a particular customer. This section details the steps necessary to do just that.

To create a customized demo, you'll first need to get details of the customer's requirements regarding the information that they want to collect when servicing items at a stop. Ideally this information will include detailed descriptions of the screens they would like to see, but it is often the case that the requirements will be sketchy at best. Using this information, lay out the task extension forms as described previously in this document.

When designing the forms, keep in mind that while this is a demo, you're also trying to sell the software application, so it is desirable to implement forms that are creative and interesting. For example, it is desirable to avoid screens that contain only rows of text entry fields. Instead, popup menus may be used with customer-specific selection options whenever possible. If the customer's requirements lack detail, the designer might still avoid rows of text entry fields by using creative extrapolation to include pop-up menus.

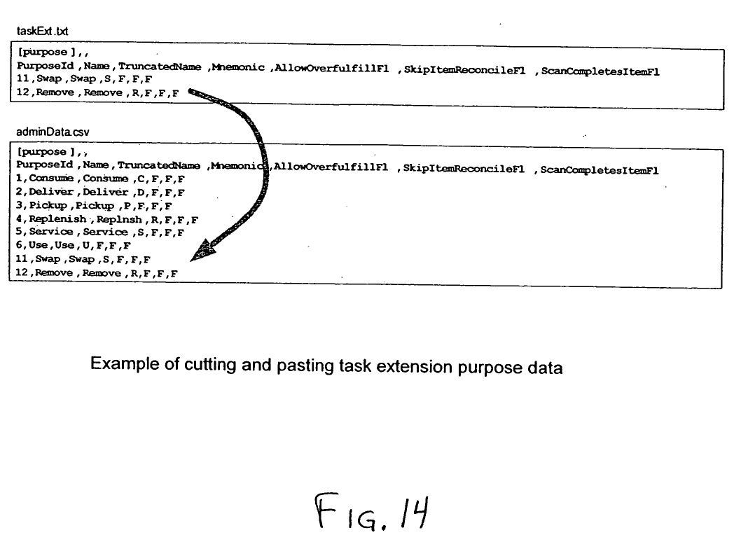

After completing and testing the forms using a task extension editor in accordance with the principles of the present invention, the task extensions are added to the demo data, e.g., by performing the following steps:
1. From the TEE main form, tap the Save button to create a suitably named file (e.g., taskExt.txt) in the device's log directory.
2. Connect the device to your desktop using ActiveSync
3. Click the Explore button in the ActiveSync window on your desktop to open a Windows Explorer window to access the device.
4. Navigate to the device's log directory, select the taskExt.txt file and copy it to your desktop machine.
5. Obtain a copy of an adminData.csv file.
6. Using a text editor, open the taskExt.txt file.
7. Find the line containing the string “[purpose]” in the taskExt file. Under it will be a line of text describing the purpose fields, and then the next lines will contain task extension purpose table entries. Select the table entries and copy them.
8. Using a text editor (not Excel!), open the adminData.csv file. Find the “[purpose]” string, and under the existing purpose entries paste the entries copied in the previous step (see FIG. 14). Do NOT leave any blank lines between the old entries and the pasted entries.
9. For this demo, when the demo data is loaded into the POD application, the order items will be evenly distributed across all of the purpose types defined in the purpose table in the adminData.csv file. You can remove any purposes that you do not want to be part of the demo by deleting their entries. For example, the Consume, Replenish, Service, and Use purposes are rarely used, so you may want to delete them from the purpose table entries.
10. In the taskExt.txt file, find the line containing the string “[preference]”, skip the next line, and copy all of the entries.
11. In the adminData.csv file, find the “[preference]” string and paste the entries copied in the previous step under any existing entries. Do NOT leave any blank lines between the old entries and the pasted entries.
12. Save the changes to the adminData.csv file.
   To install the demo on your device, perform the following steps:
1. Hard reset the device.
2. ActiveSync the device to your desktop.
3. Run the POD demo installer on your desktop.
4. After a successful installation, copy the admindata.csv file you created above to the device's Demo directory, overwriting the existing version of the file.
5. Run the POD application.

Proof-of-Service systems with task extension such as disclosed herein have many applications. For instance, a suitable user might be a corporation with mobile workers who require proof of service and additional data elements in order to bill their customers for the services provided. Certainly those persons and corporations with the need for proof of service products to support more than a defined number of services would greatly benefit from the present invention that provides task extension capabilities without the need for software customization by the software vendor.

Conventional delivery systems focus on the ability to handle two default tasks—pickups and deliveries. This focus on these two tasks isn't limited to the Deliver Packages form. Rather, it can also be found in such things as Pickup count and Delivery count that are shown on a Delivery screen when stops are displayed. Summary statistics that may be displayed at the end of the stop and during a finalize process also only take into account the two default tasks. The addition of Task Extensions typically require the client to be modified such that each of the forms (and there may be others) that contain task summary information optionally include the task extension data. In the event that displayed forms that contain such summaries may already be showing about as much information as it is possible to display in the limited screen real estate. To address the problem of lack-of-space, summarized tasks may be prioritized.

If a given Task Extension is to be made available to multiple devices, then screen layout concerns may make it desirable to qualify the extension preference keys with an additional subkey that identifies the intended platform. Thus, for the example described earlier of a “Shred” Task Extension, it might be necessary to define preferences ext.ppc.Shred and ext.palm.Shred if the Shred Task Extension capability needs to be added to both the PPC and the Palm platforms.

Alternatively, the screen coordinate data for a given extension may be moved into a separate preference specific to the device, while leaving a common preference that describes the generic screen layout without screen coordinates.

While the invention has been described with reference to the exemplary embodiments thereof, those skilled in the art will be able to make various modifications to the described embodiments of the invention without departing from the true spirit and scope of the invention.

What is claimed is:

1. A method of providing a task workflow extension feature in a proof of service system, comprising:
providing at least one editable form defined using a scripting language; and
transmitting said scripting language to a client via configuration properties.

2. The method of providing a task workflow extension feature in a proof of service system according to claim 1, wherein said task workflow extension comprises:
a retrace workflow process.

3. The method of providing a task workflow extension feature in a proof of service system according to claim 1, wherein said task workflow extension comprises:
a linear workflow process.

4. The method of providing a task workflow extension feature in a proof of service system according to claim 1, wherein said task workflow extension further comprises:
a combination of linear and retrace workflow processes.

5. The method of providing a task workflow extension feature in a proof of service system according to claim 1, further comprising:
directing entry by a user of required information via a linear workflow process; and
directing entry by a user of optional information via a retrace workflow process.

6. The method of providing a task workflow extension feature in a proof of service system according to claim 1, further comprising:
providing a preview feature to allow preview of an appearance and a behavior of a form currently being edited.

7. The method of providing a task workflow extension feature in a proof of service system according to claim 1, wherein:
said proof of service system includes a Pocket PC device.

8. The method of providing a task workflow extension feature in a proof of service system according to claim 1, wherein:
said at least one editable form is editable using an edit task form.

9. The method of providing a task workflow extension feature in a proof of service system according to claim 1, wherein:
said at least one editable form is editable using an edit label form.

10. The method of providing a task workflow extension feature in a proof of service system according to claim 1, wherein:
said at least one editable form is editable using an edit textbox form.

11. The method of providing a task workflow extension feature in a proof of service system according to claim 1, wherein:
said at least one editable form is editable using an edit popup form.

12. The method of providing a task workflow extension feature in a proof of service system according to claim 1, wherein:
said at least one editable form is editable using an edit button form.

13. A task workflow extension feature in a proof of service system, comprising:
means for providing at least one editable form defined using a scripting language; and
means for transmitting said scripting language to a client via configuration properties.

14. The task workflow extension feature in a proof of service system according to claim 13, wherein said task workflow extension comprises:
a retrace workflow process.

15. The task workflow extension feature in a proof of service system according to claim 13, wherein said task workflow extension comprises:
a linear workflow process.

16. The task workflow extension feature in a proof of service system according to claim 13, wherein said task workflow extension comprises:
a combination of linear and retrace workflow processes.

17. The task workflow extension feature in a proof of service system according to claim 13, further comprising:
means for directing entry by a user of required information via a linear workflow process; and
means for directing entry by a user of optional information via a retrace workflow process.

18. The task workflow extension feature in a proof of service system according to claim 13, further comprising:
means for providing a preview feature to allow preview of an appearance and a behavior of a form currently being edited.

19. The task workflow extension feature in a proof of service system according to claim 13, wherein:
said proof of service system includes a Pocket PC device.

20. The task workflow extension feature in a proof of service system according to claim 13, further comprising:
an edit task form to edit said at least one editable form.

21. The task workflow extension feature in a proof of service system according to claim 13, further comprising:
an edit label form to edit said at least one editable form.

22. The task workflow extension feature in a proof of service system according to claim 13, further comprising:
an edit textbox form to edit said at least one editable form.

23. The task workflow extension feature in a proof of service system according to claim 13, further comprising:
an edit popup form to edit said at least one editable form.

24. The task workflow extension feature in a proof of service system according to claim 13, further comprising:
an edit button form to edit said at least one editable form.
